(19) United States
(12) Patent Application Publication
(10) Pub. No.: US 2025/0005191 A1
(43) Pub. Date: Jan. 2, 2025

(54) SYSTEM AND METHOD FOR PROCESSING COMPLEX QUERIES WITH PERSONAL DATA

(71) Applicant: LexAnalytico consulting private limited, Bengaluru (IN)

(72) Inventor: Gyanveer Singh, Karnataka (IN)

(21) Appl. No.: 18/757,602

(22) Filed: Jun. 28, 2024

(30) Foreign Application Priority Data
Jun. 29, 2023 (IN) 202341043832

(51) Int. Cl. G06F 21/62

(52) U.S. Cl. CPC G06F 21/6227; G06F 21/6245

(57) ABSTRACT

An embodiment of the present disclosure describes a mechanism for handling a complex query that includes two or more sub-queries. To resolve the first sub-query, access to private data is required. The mechanism involves performing dependency parsing to determine the sub-queries and their dependency order. Data sources are selected based on user settings, historical data access, success records, and metadata analysis. A private data access request is generated and sent with access attributes and a custom message to the access approver. The custom message explains the reason for the request, potential impact, and duration of data use. Private data and inputs from the access approver are received, determining how the data will be used, maintained, or deleted. The first sub-query is then resolved with the received data, followed by the resolution of other sub-queries based on the dependency order.

### CROSS-REFERENCE

This application is related to and claims priority to Indian Provisional Application No. 202341043832, filed on Jun. 29, 2023, and titled “SYSTEM AND METHOD FOR PROCESSING COMPLEX QUERIES WITH PERSONAL DATA”, which is hereby incorporated by reference in its entirety.

### TECHNICAL FIELD

The present disclosure relates to the field of interactive query processing and personal information management, and particularly to a system and method for processing complex queries that involve accessing and utilizing personal data.

### BACKGROUND

The rapid advancement of technology (e.g. interactive query response systems) and the proliferation of smart devices have significantly increased the complexity and variety of user queries. Nowadays, users frequently interact with smart assistants, search engines, and other digital interfaces to obtain information, perform tasks, and manage their personal data. These interactions often involve complex queries, which may contain multiple questions with unknown answers, where formation of one query depends on the answer to another query. Traditional query processing systems, typically designed to handle simple, straightforward queries, struggle with complex queries that require multi-step processing and data from diverse sources. This inability to manage complex queries effectively results in sub-optimal user experiences, incomplete answers, and increased response times.

To resolve a complex query, data may be required from multiple sources, including both public and personal sources. For instance, a question like “What is the distance between the headquarters of company X and the home address of my friend Y?” involves public information about the company's headquarters, which can be obtained from public search engines, and confidential information about the friend's home address, which cannot be publicly accessed. Additional examples of such queries include asking for the telephone number of a clinic near a relative's house, finding medicine prescribed during a previous visit, or purchasing an accessory for a recently gifted mobile phone. These queries illustrate the need for accessing both public and personal data.

Current systems lack the logic to process these queries efficiently. Granting access to all user data to search engines or voice assistants is not a viable solution due to security concerns and user discomfort with sharing personal data, even with reputed companies. Data privacy laws such as CCPA, GDPR, and others require companies to handle personal data with great care, disclosing how, when, and for what purpose user data will be used, and for how long it will be retained. These legal requirements are challenging to comply with, leading companies to avoid handling personal data, thus restricting the features that smart assistants or interactive query response systems can offer.

Consequently, users often have to search for parts of a long query using multiple applications, each with its own set of search operators, functions, and fields. For example, Google Calendar, Gmail, Outlook, and other apps have different operators and search functions, making it inconvenient and sometimes unmanageable for users to search through multiple applications to get a complete answer. For example, let's say the user wants to plan a family vacation. The user needs to check their work calendar for available vacation days, find flight options, book a hotel, and confirm the vacation dates with their family. The user's work calendar is managed through one application, flight options are typically searched on various travel websites, hotel bookings are done through a different travel app, and family communications are handled via a messaging app.

To complete this task, the user would need to first open their work calendar application to check for available vacation days, then switch to a travel website to search for flights, then move to a hotel booking app to reserve a hotel room, and finally switch to a messaging app to confirm the vacation dates with their family. Each of these platforms has its own search operators and functions, requiring the user to manually search for and collate information from multiple sources. This process is cumbersome and time-consuming, as the user has to navigate different interfaces and search protocols to obtain a complete answer to their query.

Furthermore, the rise in data privacy concerns necessitates a sophisticated approach to handling personal data. Users are increasingly aware of their privacy rights and expect systems to seek explicit permission before accessing their personal data. This introduces additional challenges in query processing systems, which now need to incorporate mechanisms for identifying, tagging, and securely handling personal data queries while ensuring compliance with privacy regulations.

Therefore, there is a need for systems and methods capable of processing complex queries efficiently and securely, seamlessly integrating both public and personal sources of information to answer queries of significant complexity while preserving data privacy.

### BRIEF SUMMARY

One or more embodiments are directed to a system and method for processing a complex query that includes two or more sub-queries. An embodiment of the present disclosure describes a system for handling a complex query that includes two or more sub-queries, wherein to resolve the first sub-query, access to private data is required. The system involves performing dependency parsing to determine the sub-queries and their dependency order. Further, the system selects data sources based on user settings, historical data access, success records, metadata analysis, or a combination of these factors. A private data access request is generated and sent with access attributes and a custom message to the access approver. The access approver receives the request, including information about the retention period, permitted applications, and specific context in which data may be used. The custom message explains the reason for the request, potential impact, and duration for which the requested data can be used. Private data and inputs against each access attribute from the access approver is received, determining how the data will be used, maintained, or deleted. The first sub-query is then resolved with the received data, followed by the resolution of other sub-queries based on the dependency order.

In an embodiment, the system includes a query-receiving module to receive a complex query at a first user device. The first user device may be a smart assistant device, a mobile phone, a tablet computer, or a general-purpose computer. The complex query may be such that, access to a private data is required to resolve a first sub-query of the two or more sub-queries. In an embodiment, the system includes a query parser module to perform dependency parsing of the received complex query to determine the two or more sub-queries and an associated dependency order. In an embodiment, the system includes a data source selection module to select one or more data sources from a plurality of data sources, for accessing the private data. The selection of the one or more data sources is based on user settings, historical access of data types from the plurality of data sources, success records of similar private data queries from the plurality of data sources, analysis of metadata associated with each of the plurality of data sources, or a combination of.

In an embodiment, the system includes a custom private data query module to generate and send a private data access request, access attributes, and/or a custom message for access approver for the selected one or more data sources. The private data access request along with the access attributes, and the custom message is presented to the access approver. The access attributes may include information indicative of a retention period of the private data, permitted application that will use the private data, and specific context in which the private data is to be used. The custom message generated is a natural language message and includes a reason for the access request, a potential impact of the data access, and a duration for which the data will be used. Further, the custom private data query module receives the private data and inputs against each of the access attributes based on approval and interaction of the access approver. The received private data is used, maintained, or deleted based on the inputs received against each of the access attributes from the access approver.

In an embodiment, the system includes a query resolver module to resolve the first sub-query based on the received private data and subsequently resolve other sub-queries of the complex query based on the resolved first sub-query and the associated dependency order.

An embodiment of the present disclosure discloses a method for processing the complex query. The method includes receiving a complex query at a first user device. The first user device may be a smart assistant device, a mobile phone, a tablet computer, or a general-purpose computer. The complex query may include two or more sub-queries. Further, the complex query may be such that, access to a private data is required to resolve a first sub-query of the two or more sub-queries. Further, the method includes performing dependency parsing of the complex query to determine the two or more sub-queries and an associated dependency order. Furthermore, the method includes selecting one or more data sources from a plurality of data sources, for accessing the private data. The one or more data sources is selected based on user settings, historical access of data types from the plurality of data sources, success records of similar private data queries from the plurality of data sources, and analysis of metadata associated with each of the plurality of data sources or combination of. Moreover, the method includes generating and sending a private data access request, access attributes, and a custom message for access approver for the selected one or more data sources. Additionally, the method includes receiving the private data and inputs against each of the access attributes based on approval and interaction of the access approver. The method also includes resolving the first sub-query based on the received private data and subsequently resolving other sub-queries of the complex query. The other sub-queries of the complex query is resolved based on the resolved first sub-query.

The features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 depicts an exemplary environment illustrating the process of resolving a complex query, showcasing the operational framework and interactions involved, in accordance with an embodiment of the present disclosure.

FIG. 2 illustrates a block diagram of a complex query processing system for resolving a complex query, in accordance with an embodiment of the present disclosure.

FIG. 3 illustrates the various stages involved in handling the complex query, in accordance with an embodiment of the present disclosure.

FIG. 4 illustrates an interaction diagram for the complex query processing system working with both public as well as private data, in accordance with an embodiment of the present disclosure.

FIG. 5 illustrates an exemplary dependency tree, in accordance with an embodiment of the present disclosure.

FIG. 6 illustrates various exemplary GUI(s) for seeking permission for access to private data from a user initiating the query, in accordance with an embodiment of the present disclosure.

FIG. 7 illustrates various exemplary GUI(s) for seeking permission for access to private data from a third-party user, in accordance with an embodiment of the present disclosure.

FIG. 8 is a flow chart of a complex query processing method for resolving a complex query, in accordance with an embodiment of the present disclosure.

FIG. 9 illustrates an exemplary computer unit in which or with which embodiments of the present disclosure may be utilized.

Other features of embodiments of the present disclosure will be apparent from the accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to a system and method for complex query processing system and method for resolving a complex query. The present disclosure provides mechanisms for seamlessly executing/resolving complex queries composed of multiple sub-queries, with some requiring access to private data. The system receives and parses the complex query to identify and order the sub-queries based on their dependencies. To access the necessary private data, the mechanism selects appropriate data sources by considering factors such as user settings, historical access patterns, success rates of similar queries, and metadata analysis. A custom request for private data access, including access attributes and a message for the access approver, is generated and sent to the selected data source. The access approver, using a secondary device, reviews and interacts with the request, providing the necessary data upon approval. The mechanism then resolves the initial sub-query with the obtained data and subsequently addresses the remaining sub-queries according to the established dependency order.

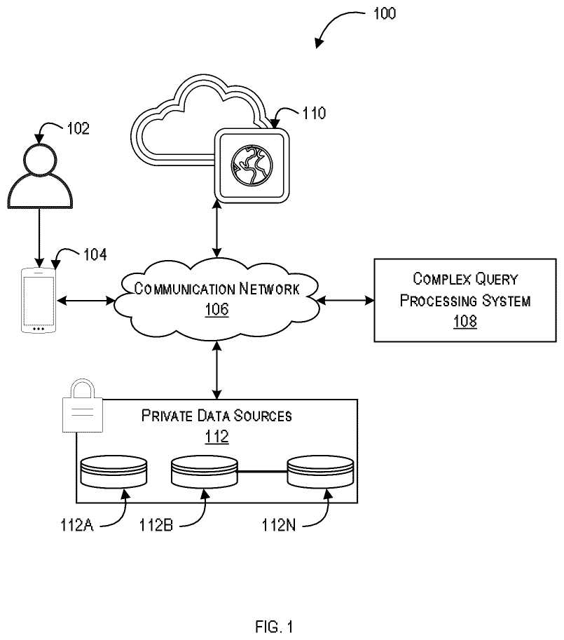

FIG. 1 depicts an exemplary environment 100 illustrating the process of resolving a complex query, showcasing the operational framework and interactions involved, in accordance with an embodiment of the present disclosure. In an embodiment, the environment 100 may include a user 102 and a first user device 104, a communication network 106, a Complex Query Processing System 108, public databases 110, and private data sources 112. The user 102 may include an individual or an entity interacting with the complex query processing system 108 (hereinafter also referred to as system 108) to resolve the complex query. The complex queries may be formulated either in text or voice format. Further, the user may include, but not limited to, a researcher looking for specific scientific data, a business analyst seeking insights from various datasets, or a general user trying to find specific information that may require both public data and private data. Furthermore, the user 102 may utilize the first user device 104 (hereinafter also referred to as user device 104) to submit complex queries through various interfaces such as a web browser, search engine, interactive query response systems, or smart assistant.

In an embodiment, the interactive query response systems are platforms or software that may allow users to input questions or commands and receive detailed responses. Leveraging artificial intelligence (AI) and natural language processing (NLP) technologies, they are designed to interact with users in a conversational manner, often through text or voice inputs, and can provide answers by searching databases, performing computations, or connecting to other services. Examples include customer support chatbots, virtual assistants on websites, and automated help desks that guide users through troubleshooting steps or provide information about products and services. In an embodiment, the smart assistants are AI-powered tools integrated into devices such as smartphones, smart speakers, and computers. They use voice recognition and NLP to understand and execute user commands. Further, the smart assistants perform a variety of tasks such as setting reminders, sending messages, making phone calls, controlling smart home devices, providing weather updates, and answering general knowledge questions. Furthermore, the smart assistants are designed to learn from user interactions and improve their responses over time, becoming more personalized and efficient in assisting with daily tasks.

In an embodiment, the communication network 106 may facilitate the interaction between the user 102, the user device 104, and the system 108. The communication network 106 may, without any limitation, include a direct interconnection, a Local Area Network (LAN), a Wide Area Network (WAN), a wireless network (e.g., using Wireless Application Protocol), the Internet, Bluetooth, Wireless Fidelity (Wi-Fi), Universal Serial Bus (USB) connectivity, or another connectivity infrastructure. In an embodiment, the user device 104 may be, but is not limited to, a smartphone, a Personal Assistant Device (PDA), a PC, a tablet, a laptop, a smartwatch, a smart assistant, a VR-AR device, a general-purpose computer and so on. In an embodiment the first user device may be a smart assistant device, a mobile phone, a tablet computer, or a general-purpose computer. The interface may include but is not limited to, a display screen, a microphone, a speaker, a camera, and so on. In an embodiment, the system 108 may work as an independent service, part of an operating system integrated with a smart assistant environment, or integrated with an interactive query response system.

In an embodiment, the complex query may be a detailed and multifaceted request for information that includes two or more interrelated sub-queries. The interrelated sub-queries may be structured in a way that their resolution is dependent on a specific order or hierarchy, often requiring access to multiple data sources. Further, complex queries may include questions or requests that necessitate the extraction, correlation, and integration of diverse data points to generate a comprehensive answer. Furthermore, the complex queries may involve retrieving and synthesizing data from the public database 110 and the private data sources 112, analyzing historical and real-time information, or performing in-depth searches that go beyond simple keyword matching. The complexity arises from the need to parse, interpret, and resolve these sub-queries in a coherent and sequential manner to provide accurate and meaningful results.

In an embodiment, the public database 110 may store data accessible to anyone, such as general information, statistics, or publicly released documents. Further, the public database 110 may include open-access scientific journals, public records, government databases, educational resources, and any other data sources that provide free access to information. In an embodiment, the private data sources 112 may contain sensitive or restricted information requiring specific permissions for access, such as personal data, confidential company records, or proprietary research. Further, access to the private data sources 112 may be controlled and requires explicit permission, often involving secure authentication and authorization processes. Furthermore, the private data sources 112 may include proprietary business documents, confidential research data, personal information protected by privacy laws, internal organizational records, and other sensitive data. Access to this information is typically governed by privacy policies, regulatory requirements, or organizational security protocols. Moreover, access to the private data sources 112 may resolve sub-queries that need specific, confidential information that cannot be obtained from public sources.

In an environment, the private data sources 112 may include more than one such private data sources (as shown by 112A, 112B, . . . , 112N). Each of these data sources may serve different purposes and contain distinct sets of data. For example, database source 112A may store personal data, such as user profiles, health records, or financial information, requiring stringent privacy measures and user consent for access. The database source 112B may house confidential company records, including business strategies, financial reports, and internal communications, necessitating access control to protect business interests and maintain competitive advantage. In an embodiment, each database source may have tailored access controls and security protocols to meet specific data protection requirements.

In an embodiment, the system 108 may handle complex queries, which may include two or more sub-queries. When a complex query is received at the user-associated device 104, the query may be transmitted over the communication network 106 to the system 108. The system 108 may break down the complex query into its sub-queries and determine their dependency order. In an embodiment, if resolving a sub-query requires accessing private data 112, the system may access appropriate private data sources, considering factors like user settings and historical access patterns. For instance, to resolve a sub-query needing private data, the system 108 may require access and/or permission to the relevant private data sources 112. Upon receiving the necessary permissions and data, the system 108 may proceed to resolve the first sub-query and, subsequently, the other sub-queries based on their dependency order.

This interaction ensures that complex queries, which span multiple data sources and require both public and private data, are efficiently and accurately resolved, providing the user 102 with a comprehensive answer. The environment depicted in FIG. 1 showcases the operational framework that bridges the gap between diverse data sources and the complex queries posed by users.

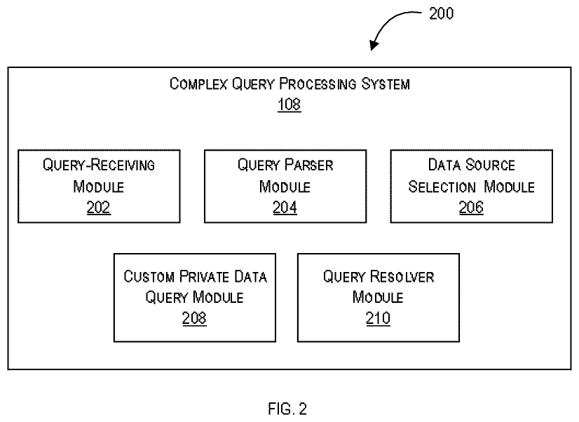

FIG. 2 illustrates a block diagram 200 of a complex query processing system 108 for resolving a complex query, in accordance with an embodiment of the present disclosure. In an embodiment, the system 108 may include a query-receiving module 202, a query parser module 204, a data source selection module 206, a custom private data query module 208, and a query resolver module 210. The query-receiving module 202 may receive a complex query including two or more sub-queries at a first user device 104. The first user device may be a smart assistant device, a mobile phone, a tablet computer, or a general-purpose computer. The complex query may require access to private data to resolve a first sub-query of the two or more sub-queries. Further, the complex query may be a text query, a voice query, or a combination. In an embodiment, the query-receiving module 202 may accept complex queries comprising two or more interrelated sub-queries from user 102. The complex queries, which may be in the form of text, voice commands, or a combination thereof, initiate a structured process within the system 108. The complexity of such queries often necessitates accessing private data to effectively resolve at least one of the initial sub-queries among the multiple interrelated ones. Further, the query-receiving module 202 may act as the initial point of interaction between the user 102 and the system 108. This module is equipped to handle various input formats, ensuring flexibility in accommodating user preferences and technological capabilities. Whether the user inputs a detailed textual query or articulates a request via voice command, the query-receiving module 202 may capture and prepare the query for further processing by the system 108.

In an embodiment, the query parser module 204, may perform dependency parsing of the received complex query to determine the two or more sub-queries and an associated dependency order. The query parser module 204 may break down the complex query into its constituent sub-queries, ensuring that each sub-query is appropriately identified and structured for subsequent processing. Further, the query parser module 204 may employ advanced natural language processing (NLP) techniques to understand and interpret the user input. By leveraging NLP, the query parser module 204 may accurately parse the query, identifying key components, relationships, and dependencies among the sub-queries. This is particularly important for complex queries that require a specific order of resolution or where certain sub-queries are dependent on the results of others. Furthermore, the query parser module 204 may assess the dependency hierarchy of the sub-queries. The assessment may include understanding which sub-queries need to be resolved first and how their results will impact the subsequent sub-queries. By establishing the hierarchy, the query parser module 204 ensures that the complex query is resolved in a logical and coherent sequence, thereby enhancing the accuracy and relevance of the final output.

In an embodiment, the query parser module 204 may employ a query tree construction logic to perform dependency parsing of the complex query. The query tree construction logic may dissect the complex query into its constituent sub-queries and establish the associated dependency order, ensuring that the resolution process is both systematic and coherent. Further, the query tree construction logic may involve creating a structured representation of the complex query in the form of a query tree. This tree structure visually and logically maps out the relationships and dependencies among the sub-queries, making it easier to manage and resolve them in an organized manner. Each node in the query tree represents a sub-query, while the edges between nodes denote the dependencies and the sequence in which they must be addressed. In an embodiment, the dependency order established by the query parser module 204 ensures that each sub-query is resolved in the correct sequence, taking into account any prerequisite data or results needed from other sub-queries. For instance, if resolving one sub-query is contingent upon the results of another, the dependency tree will reflect this relationship, guiding the system 108 to address the sub-queries in the appropriate order. Further, the query parser module 204 may perform dependency parsing and determine the sub-queries and their associated dependency order to ensure that complex queries are broken down into manageable parts and resolved in a coherent and logical sequence.

In an embodiment, the data source selection module 206 may select one or more data sources from a plurality of data sources (may also be referred to as private data sources 112), for accessing the private data, based on any or combination of user settings, historical access of data types from the plurality of data sources, success records of similar private data queries from the plurality of data sources, and analysis of metadata associated with each of the plurality of data sources. The data source selection module 206 may enhance the efficiency and accuracy of the complex query processing system 108 by selecting the most appropriate data sources for accessing private data. Further, the data source selection module 206 may systematically evaluate and select the one or more data sources from the plurality of options. Furthermore, the data source selection module 206 may consider user settings, which encompass the preferences and configurations specified by the user 102. The user settings may include particular data sources that have been authorized for accessing private information or expressed a preference for using. By adhering to these user-defined settings, the data source selection module 206 may ensure that the data retrieval process respects the user's privacy requirements and aligns with their preferences.

In an embodiment, the data source selection module 206 may take into account historical access patterns of data types from the plurality of data sources. Further, the data source selection module 206 may analyze past interactions and the types of data previously accessed for similar queries. Furthermore, the data source selection module 206 may leverage the historical data to predict which sources are likely to yield the most relevant and accurate information for the current complex query. Moreover, the data source selection module 206 may also evaluate the success records of similar private data queries from the plurality of data sources. By examining the outcomes of previous queries that are similar in nature, the data source selection module 206 may identify data sources that have a proven track record of providing reliable and accurate results. Additionally, the data source selection module 206 analysis may help in selecting sources that are more likely to contribute to the successful resolution of the current complex query.

In an embodiment, the data source selection module 206 may conduct an analysis of metadata associated with each of the plurality of data sources. Metadata associated with the each of the plurality of data sources may include information about the content type, update frequency, reliability, access restrictions, the source's credibility, etc. The content type metadata may help determine the nature of the data stored, such as text, numerical data, or multimedia. The update frequency metadata may indicate how often the data source is refreshed, ensuring that the most current information is used. Reliability metadata may provide insights into the accuracy and consistency of the data source. Access restrictions metadata may outline any permissions or security requirements necessary to access the data. Source credibility metadata assesses the trustworthiness and authority of the data provider.

In an embodiment, the data source selection module 206 may employ a comprehensive and multifaceted approach to select the most appropriate data sources for accessing private data. By considering user settings, historical access patterns, success records, and metadata analysis, the data source selection module 206 may ensure that the system 108 can efficiently and accurately resolve the sub-queries within a complex query, thereby providing the user 102 with precise and comprehensive answers.

In an embodiment, the custom private data query module 208 may generate and send a private data access request, access attributes, and/or a custom message for access approver for the selected one or more data sources. The private data access request along with the access attributes, and the custom message may be presented to an access approver. The access approver may be the individual about whom access to private data is being requested. Further, the access approver may facilitate responsible data access by reviewing access requests, considering relevant factors, and making informed decisions to maintain data security and integrity. In an embodiment, the access approver may be the user 102 initiating the complex query, responsible for ensuring compliance with privacy regulations and organizational policies. In such scenarios, the user may use the user device 104 to approve access to the private data. In an alternate embodiment, the access approver might be a designated third-party and/or a second-user with the authority to grant access permissions to sensitive information. In such scenarios, the designated third-party and/or a second-user may use the associated user-device (may also be referred to as a second user-device) to approve access to the private data. Regardless of their specific role,

In an embodiment, the access attributes may include information indicative of a retention period of the private data, permitted application that will use the private data, and/or specific context in which the private data is to be used. The custom message generated may be a natural language message and may include a reason for the access request, a potential impact of the data access, and/or a duration for which the data will be used. In an embodiment, the custom private data query module 208 may receive the private data and inputs against each of the access attributes based on approval and interaction of the access approver. The private data is used, maintained, or deleted based on the inputs received against each of the access attributes from the access approver.

In an embodiment, the custom private data query module 208 may facilitate a secure authorized access to private data from selected data sources. The custom private data query module 208 may generate and manage the interactions required to obtain private data, ensuring that all access is properly authorized and tracked. Further, the custom private data query module 208 may generate and send private data access requests to the relevant data sources. The private data access request may include specific access attributes and custom messages intended for the access approver. The access attributes may provide detailed information about the nature of the request, such as the retention period of the private data, the permitted applications that will use the data, and the specific context in which the data will be used. The attributes help the access approver understand the scope and limitations of the data request, ensuring that it aligns with organizational policies and regulatory requirements. The custom message may be crafted in natural language and serve to provide additional context and justification for the data access request. Further, the custom message may include key elements such as the reason for the access request, the potential impact of granting access to the data, and the duration for which the data will be used. By presenting this information clearly and concisely, the custom private data query module 208 may facilitate informed decision-making by the access approver.

Upon generation, the private data access request, along with the access attributes and custom message, is sent to the access approver to review the request. In an embodiment, once the access approver interacts with the request and grants approval, the custom private data query module 208 may receive the private data and any required inputs against each of the access attributes. Further, the custom private data query module 208 may ensure that the system 108 not only obtains the necessary data but also adheres to the specified conditions of use, retention, and application. Furthermore, the custom private data query module 208 may manage the secure access and retrieval of private data. By generating detailed access requests with specific attributes and natural language messages, the custom private data query module 208 ensures that all data access is properly authorized and aligned with the intended use.

In an embodiment, the query resolver module 210 may resolve the first sub-query based on the received private data and subsequently resolve other sub-queries of the complex query based on the resolved first sub-query and the associated dependency order. The query resolver module 210 may initiate operation by focusing on the first sub-query of the complex query, which may require access to private data. Once the private data is received, the query resolver module 210 may utilize the received data to resolve the first sub-query. Further, the query resolver module 210 may ensure that the data used is relevant and precise. After successfully resolving the first sub-query, the query resolver module 210 may proceed to the next sub-queries in accordance with the associated dependency order. The associated dependency order may dictate the sequence in which the sub-queries may be resolved. Further, the associated dependency order may ensure that each step builds upon the results of the previous ones.

In an embodiment, query resolver module 210 may systematically address each sub-query, utilizing the outputs from resolved sub-queries to inform and guide the resolution of subsequent ones. For example, if the first sub-query involves obtaining specific user data from the private data sources 112, the resolved data might be used to filter or refine searches in public databases 110 for subsequent sub-queries. The query resolver module 210 may leverage this dependency to enhance the accuracy and relevance of the final output. By following the dependency order, query resolver module 210 ensures a coherent and logical progression through the complex query, avoiding potential errors or inconsistencies that could arise from out-of-order processing.

In an embodiment, the query resolver module 210 may employ advanced algorithms and data integration techniques to synthesize information from various sources. Further, the query resolver module 210 may combine and correlate data, ensuring that the final response to the complex query is comprehensive and meaningful. Furthermore, the query resolver module 210 may handle any iterative processes required, where the resolution of one sub-query might necessitate revisiting or re-evaluating previously resolved sub-queries based on new insights or data. Moreover, the query resolver module 210 by resolving the first sub-query based on received private data and systematically addressing subsequent sub-queries in the correct dependency order, may ensure accurate, efficient, and coherent query resolution. Additionally, the query resolver module 210 may integrate and synthesize data from multiple sources significantly to provide precise and comprehensive answers to complex queries, thereby improving the overall user experience.

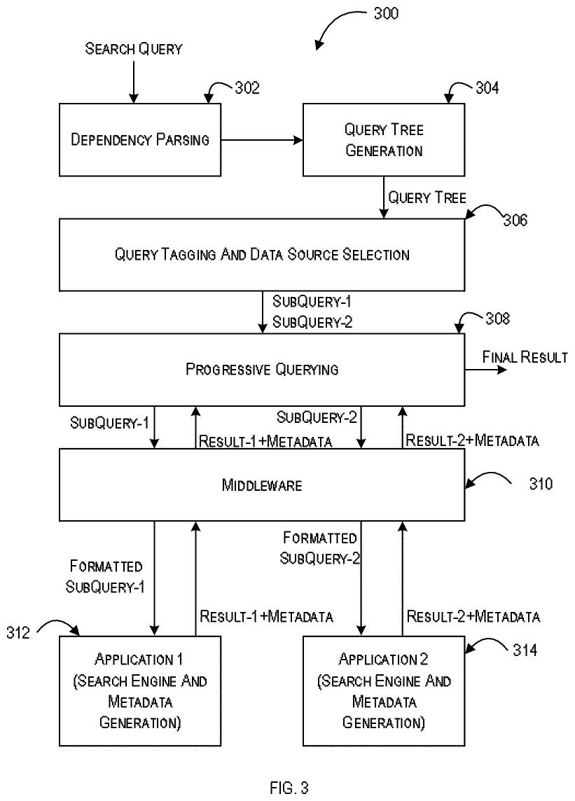

FIG. 3 illustrates the various stages 300 involved in handling the complex query, in accordance with an embodiment of the present disclosure. In an embodiment, the processing of the complex query involves a series of well-defined process to ensure accurate and efficient resolution. During the dependency parsing, as shown by 302, the system 108 may perform a detailed grammatical analysis of the search query to identify the relationships between its various components. The dependency parsing may facilitate in understanding the structure and dependencies within the query, which helps in accurately breaking it down into manageable parts. Next, at query tree generation stage, as shown by 304, involves generating the query tree based on the parsed query. The query tree may visually and logically represent the hierarchical structure of the query, mapping out the dependencies and relationships among the sub-queries. Each node in the tree may correspond to a sub-query, and the edges may indicate the sequence in which they need to be resolved. Next, at query tagging and data source selection stage, as shown by 306, tagging of each component of the query with relevant metadata may occur. The metadata tagging helps in identifying the nature and requirements of each sub-query. For instance, sub-query-1 and sub-query-2 may be tagged with specific metadata. Concurrently, the system 108 may select appropriate data sources from a pool of available sources. The selection is based on factors such as user settings, historical access patterns, and the success records of similar queries.

The process then moves to progressive querying stage, as shown by 308. The system 108 processes the query tree progressively, resolving each sub-query in the order determined by the dependency parsing and query tree generation stages. For example, resolving subquery-1 generates result-1 along with its metadata, and resolving subquery-2 generates result-2 along with its metadata. The resolution follows a logical and coherent sequence, leveraging the results of previously resolved sub-queries to provide a final integrated output. A middleware, as shown by 310, may serve as an intermediary layer that may facilitate communication between different applications and the query processing system 108. The middleware may ensure seamless data flow and integration, handling any necessary data transformations and protocol translations. For instance, it manages the flow of formatted subquery-1 and formatted subquery-2 to the respective applications.

Specific applications then process parts of the query. Application 1 (Search Engine and Metadata Generation), as shown by 312, may represents one application or search engine tasked with handling a specific sub-query. The application processes the formatted sub-query and generates results along with associated metadata. Similarly, Application 2 (Search Engine and Metadata Generation), as shown by 314, may represent another application or search engine tasked with processing another sub-query, generating its results and metadata. The stage-by-stage process may accurately and efficiently resolve the complex queries by systematically breaking them down, processing them through various applications, and integrating the results into a coherent final output.

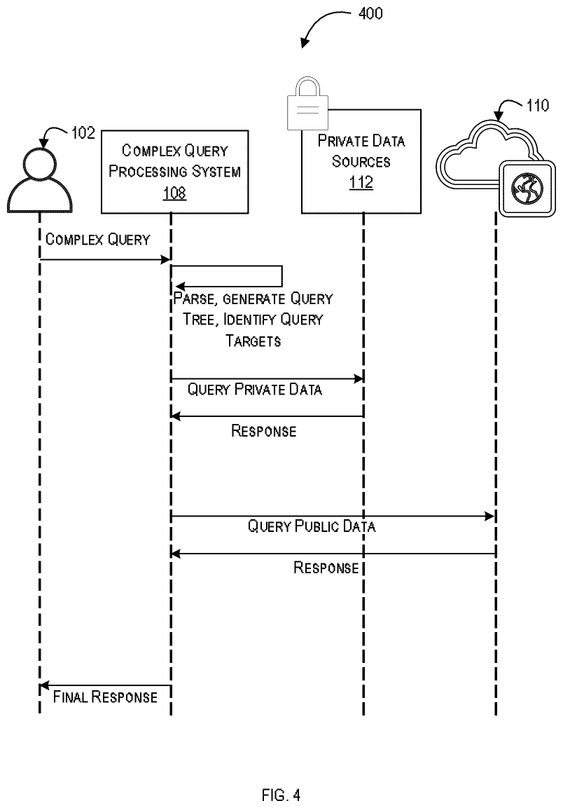

FIG. 4 illustrates an interaction diagram 400 for the complex query processing system 108 working with both public as well as private data, in accordance with an embodiment of the present disclosure. The interaction diagram 400 showcases the comprehensive workflow involving the user 102, the complex query processing system 108, the public databases 110, and private data sources 112. Further, the interaction diagram 400 details the process by which the complex query processing system 108 interacts with both public and private data to resolve complex queries. The process begins with the user 102 submitting the complex query through various interfaces such as a web browser, search engine, or smart assistant. The complex queries may be formulated either in text or voice format. Further, the complex query may be multifaceted, necessitating access to diverse data sources to provide a complete and accurate response. The system 108 may first parse the query, breaking it down into sub-queries and determining their dependency order. Upon identifying the sub-queries, the system 108 may interact with the appropriate databases. For sub-queries that require public information, the system 108 queries the public databases 110. For sub-queries that necessitate access to private information, the system 108 may send specific requests to the private data sources 112. The private data sources 112 may hold sensitive and restricted data. The interaction with these databases is tightly controlled, requiring appropriate permissions and often involving secure authentication processes.

In an embodiment, the system 108 may manage these interactions in parallel or sequentially based on the dependency order of the sub-queries. As the system 108 retrieves data from both public and private sources, it integrates and synthesizes this information to resolve each sub-query. The integrated data is then used to progressively build towards a comprehensive resolution of the entire complex query. Once all the sub-queries are resolved, the system 108 combines the results into a final response, which is then provided to the user 102. The final response may be coherent and comprehensive, addressing all aspects of the complex query by leveraging data from multiple sources. The process may ensure that even the most intricate and detailed queries can be answered accurately and efficiently by utilizing both public and private data repositories.

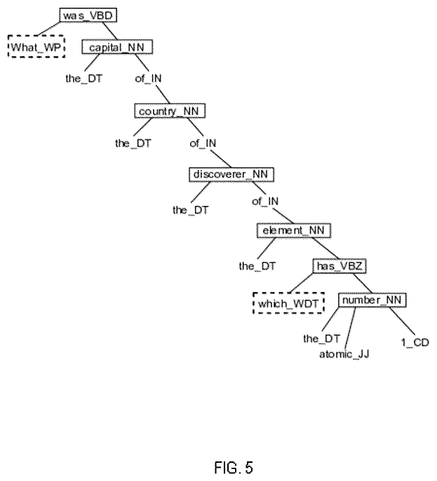

FIG. 5 illustrates an exemplary dependency tree, in accordance with an embodiment of the present disclosure. In an embodiment, the dependency structure of the dependency tree begins with the root node “What,” tagged as a Wh-pronoun (WP), which serves as the primary question word, setting the foundation of the query. The next level in the dependency is the noun “capital,” which is directly dependent on “What” and linked through the past tense verb “was.” This establishes the first layer of dependency, indicating that “capital” is the main subject being queried about. The term “capital” is further connected to the noun “country” by the preposition “of,” creating the second level in the hierarchical structure. Here, “country” depends on “capital,” forming the second sub-query. This relationship signifies that the query about “capital” involves the “country” it belongs to. The noun “country” then connects to “discoverer” through another preposition “of,” adding another layer to the dependency and forming the third sub-query. In this layer, “discoverer” depends on “country” indicating that the country in question is associated with a discoverer.

Subsequently, “discoverer” is linked to the noun “element” via yet another “of” preposition, representing the fourth hierarchical level and sub-query. Here, “element” is dependent on “discoverer,” signifying that the discoverer is related to an element. The noun “element” is connected to a relative clause introduced by “which,” tied to the verb “has.” This forms the fifth level of the hierarchy, leading to the final sub-query focused on “number,” a noun described by the adjective “atomic” and specified by the cardinal number “1.” In this level, “number” is dependent on “element” and the clause introduced by “which,” indicating that the element has an atomic number.

In an embodiment, the system 108 may determine for each node of the dependency tree whether the associated data is public or personal. Depending on the data/entity type of the connecting node, the system 108 may tag the node and associated sub-queries as a “public query” or a “personal data query.” A predefined list of data/entity types that should be tagged as private data can be used. For instance, any sub-query requiring location history, purchase history, relationships, financial transactions, personally identifiable information, health records, etc., can be tagged as a “private data query.”

In an embodiment, the system 108 may perform the progressive queries by sending sub-queries to respective data sources. Using the answer from the first data source, the system 108 may further query another data source or public information. This process of handling complex queries, particularly the progressive queries using the dependency tree, allows for the use of multiple information sources or search engines. Each of these sources may access a set of personal data to obtain results. For example, along with general search engines, personal data repositories, services, or apps can be used to get the results of sub-queries. Data sources can be selected using rules that consider which sources are most appropriate for specific types of queries (e.g., travel-related data from travel apps, health data from health apps, meeting data from calendar-keeping apps, etc.).

In an embodiment, the system 108 may select the data source based on keywords in the sub-query. The system 108 may select the most appropriate data source for a given sub-query, depending on the past success or failure history for a type of data from a data source, the system may select the most appropriate data source for a given sub-query. In an embodiment, the dependency tree may illustrate how the complex query is systematically broken down into multiple sub-queries. Each sub-query is dependent on the resolution of the previous one, facilitating a step-by-step approach to accurately resolving the overall complex query.

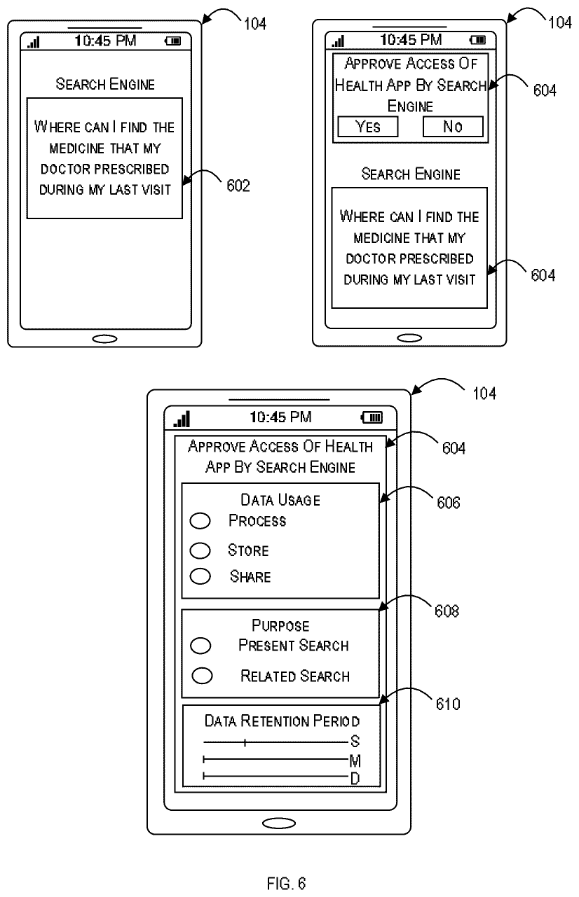

FIG. 6 illustrates various exemplary GUI(s) for seeking permission for access to private data from the user 102 initiating the query, in accordance with an embodiment of the present disclosure. In an embodiment, the user 102 may initiate a complex query 602 to the search engine, using the user device 104. The complex query 602 may involve sensitive information, such as a health-related question requiring access to private medical data. Upon receiving the complex query 602, the search engine may utilize the system 108 to generate an approval notification 604, prompting the user 102 to approve access to the associated e-health application by the search engine. The notification 604 ensures user consent before any data access is granted, maintaining user privacy and compliance with data protection regulations.

In an embodiment, once access is approved, the user 102 may further limit the data usage by the search engine, as shown by 606. The user 102 may have the control over this section, specifying and limiting the exact purposes for which their data can be used, thereby ensuring that their data is only utilized for their intended purposes. Further, the user 102 may have the control to define these limitations, ensuring that the private data is used strictly within the parameters they set, such as restricting the data to be used only within the current session or for specific purpose/functionalities, as shown by 608, preventing its use for unrelated activities. Furthermore, the user 102 may limit the data retention period, as shown by 610, about how long their data will be stored. Moreover, the user 102 may clarify whether the private data will be retained for days, months, or years, and under what conditions it will be deleted.

In an embodiment, each data source, when returning personal and/or private data, may associate additional metadata indicating who (app) can access it, how it is to be handled (holder, process, further sharing with others), the purpose of its use (e.g., only related to queries in the present context or related content), and the duration for which the shared private data can be used (data retention time). The data source may associate this metadata depending on the type of private data being shared and the purpose for which another app is requesting it. In an embodiment, the system 108 facilitates full transparency regarding the usage of personal data and also restricts others from using the data beyond the intended and limited purpose. Under existing privacy policies and practices, users, after granting access to such private data, have limited control over how the private data is used.

In an embodiment, on receiving the response (prescribed medicines: Dolo 650 and Azithromycin) from the e-health app, the system 108 (assuming the proposed system is integrated with search engine) may search for “where can I find the Dolo-650 and Azithromycin” and present the result to the user. While maintaining the search log, the names of the medicines will be abstracted after a certain time or at the end of the event as per the metadata. The search engine log or browser history will show the search log as “where can I find the medicine-1 and the medicine-2”.

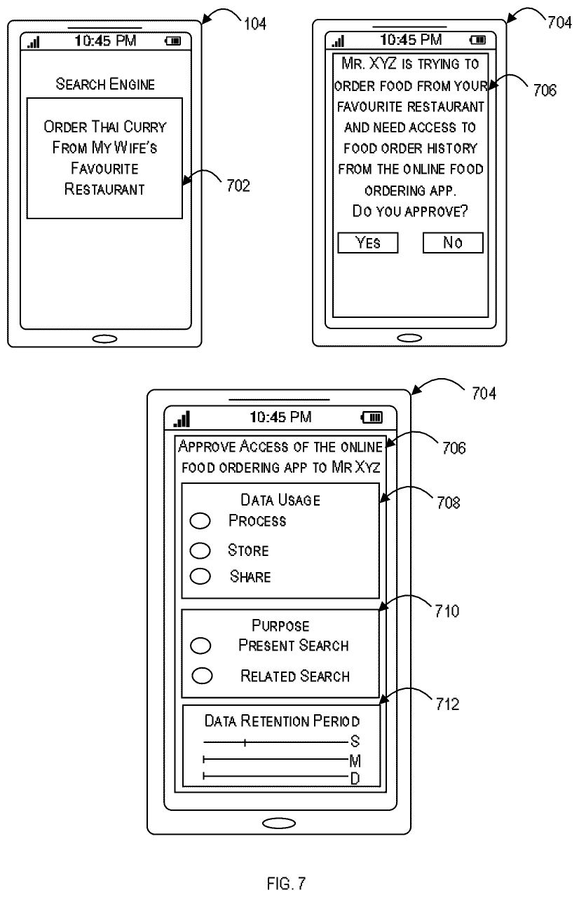

FIG. 7 illustrates various exemplary GUI(s) for seeking permission for access to private data from a third-party user, in accordance with an embodiment of the present disclosure. In this scenario, the user 102 may initiate a complex query 702 to the search engine, using the user device 104. The complex query 702 may involve actions that require access to private data held by the third-party. The third-party may be an approver and/or someone authorized to grant access to the private data needed to fulfill the complex query. For instance, the complex query 702 may involve ordering food or accessing shared resources, where approval from the third-party is necessary. The search engine, via the system 108, may communicate with the third-party using the third-party user device 704. Further, the search engine may send an approval notification 706, to the third-party user device 704, requesting approval for access. The approval notification 706 may inform the third-party about the request details, ensuring they can make an informed decision. The request detail may be a customized message, such as “Mr. XYZ is trying to order food from your favorite restaurant and needs access to food order history from the online food ordering app. Do you approve?”. Further, the detailed message helps the third-party understand the context and necessity of the request.

In an embodiment, once access is approved, the third-party may further limit the data usage by the search engine, as shown by 708. The third-party may have the control over this section, specifying and limiting the exact purposes for which their data can be used, thereby ensuring that their data is only utilized for their intended purposes. Further, the third-party may have the control to define these limitations, ensuring that the private data is used strictly within the parameters they set, such as restricting the data to be used only within the current session or for specific purpose/functionalities, as shown by 710 preventing its use for unrelated activities. Furthermore, the third-party may limit the data retention period, as shown by 712, about how long their data will be stored. Moreover, the third-party may clarify whether the private data will be retained for days, months, or years, and under what conditions it will be deleted.

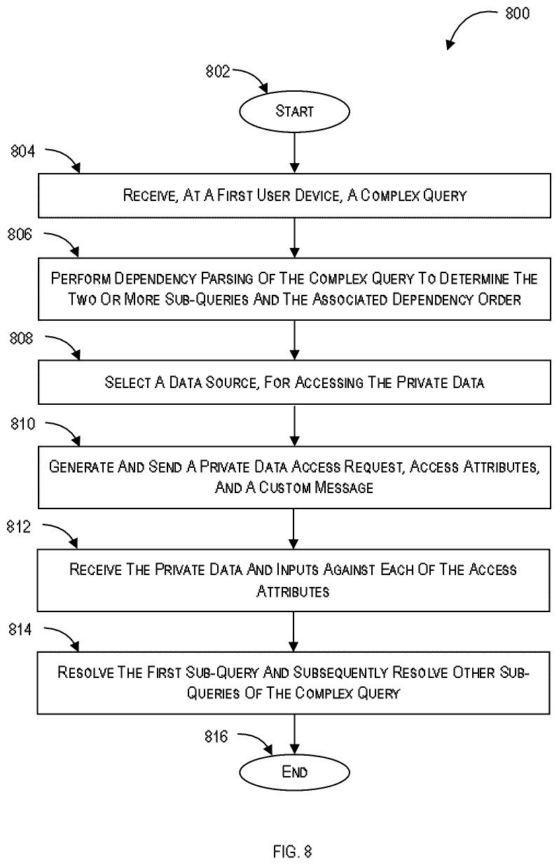

FIG. 8 is a flow chart 800 of a complex query processing method for resolving a complex query, in accordance with an embodiment of the present disclosure. The method starts at step 802. At first, a complex query comprising of two or more sub-queries may be received at a first user-device, at step 804. The first user device may be a smart assistant device, a mobile phone, a tablet computer, or a general-purpose computer. The complex query may be a text query, a voice query, or a combination. The complexity of such queries often necessitates accessing private data to effectively resolve at least one of the initial sub-queries among the multiple interrelated ones.

At step 806, dependency parsing of the complex query may be performed to determine the two or more sub-queries and an associated dependency order. The dependency parsing may include leveraging NLP to accurately parse the query and identify key components, relationships, and dependencies among the sub-queries. This is particularly important for complex queries that require a specific order of resolution or where certain sub-queries are dependent on the results of others. Assessment of the dependency hierarchy of the sub-queries is done to understand which sub-queries need to be resolved first and how their results will impact the subsequent sub-queries. In an embodiment, the method includes employing a query tree construction logic to perform dependency parsing of the complex query. The query tree construction logic may dissect the complex query into its constituent sub-queries and establish the associated dependency order, ensuring that the resolution process is both systematic and coherent. Further, the query tree construction logic may involve creating a structured representation of the complex query in the form of a query tree. This tree structure visually and logically maps out the relationships and dependencies among the sub-queries, making it easier to manage and resolve them in an organized manner. Each node in the query tree represents a sub-query, while the edges between nodes denote the dependencies and the sequence in which they must be addressed.

One or more data sources from a plurality of data sources may be selected for accessing the private data, at step 808. The selection may be based on user settings, historical access of data types from the one or more data sources, success records of similar private data queries from the one or more data sources, and/or analysis of metadata associated with each of the one or more data sources. In an embodiment, the method includes systematically evaluating and selecting the one or more data sources from the plurality of options. The evaluation and selection may be done considering user settings, which encompass the preferences and configurations specified by the user. The user settings may include particular data sources that have been authorized for accessing private information or expressed a preference for using.

Next, at step 810, a private data access request, access attributes, a custom message, or a combination of these may be generated and sent to an access approver for the selected data source. The access attributes may include information indicative of a retention period of the private data, permitted application that will use the private data, and/or specific context in which the private data is to be used. The custom message generated may be a natural language message and may include a reason for the access request, a potential impact of the data access, and/or a duration for which the data will be used.

The private data and inputs against each of the access attributes may be received, at step 812. Further, the private data and inputs against each of the access attributes may be based on approval and interaction of the access approver. The access approver may limit the data usage by specifying and limiting the exact purposes for which their data can be used, thereby ensuring that their data is only utilized for their intended purposes. Further, the access approver may have the control to define these limitations, ensuring that the private data is used strictly within the parameters they set, such as restricting the data to be used only within the current session or for specific functionalities preventing its use for unrelated activities. Furthermore, the access approver may limit the data retention period about how long their data will be stored. Moreover, the access approver may clarify whether the private data will be retained for days, months, or years, and under what conditions it will be deleted.

Next, at step 814, the first sub-query based on the received private data may be resolved, and subsequently, other sub-queries of the complex query may be resolved. Further, other sub-queries of the complex query may be resolved based on the resolved first sub-query and the associated dependency order. Once the first sub-query is resolved, the method includes addressing the other sub-queries within the complex query. The resolution of these subsequent sub-queries is directly influenced by the outcome of the first sub-query. Specifically, the information or results obtained from the first sub-query are used to inform and guide the resolution of the other sub-queries. Further, the sequence in which the remaining sub-queries are resolved follows a predefined dependency order. This dependency order is determined during the initial parsing of the complex query, where the relationships and dependencies between the sub-queries are analyzed and established. As a result, each sub-query is resolved in a logical sequence, ensuring that any required data or outcomes from previous sub-queries are available and utilized effectively. The method ends at step 816.

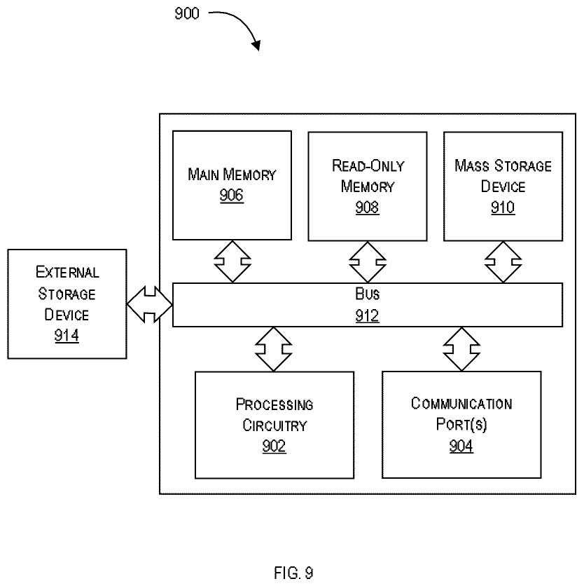

FIG. 9 illustrates an exemplary computer system in which or with which embodiments of the present disclosure may be utilized. As shown in FIG. 9, a computer system 900 includes an external storage device 914, a bus 912, a main memory 906, a read-only memory 908, a mass storage device 910, a communication port 904, and a processor 902.

Those skilled in the art will appreciate that computer system 900 may include more than one processor 902 and communication ports 904. Examples of processor 902 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 902 may include various modules associated with embodiments of the present disclosure.

The communication port 904 can be any of an RS-232 port for use with a modem-based dialup connection, a 10/100 Ethernet port, a Gigabit or 10 Gigabit port using copper or fiber, a serial port, a parallel port, or other existing or future ports. The communication port 904 may be chosen depending on a network, such as a Local Area Network (LAN), Wide Area Network (WAN), or any network to which the computer system connects.

The memory 906 can be Random Access Memory (RAM), or any other dynamic storage device commonly known in the art. Read-Only Memory 908 can be any static storage device(s) e.g., but not limited to, a Programmable Read-Only Memory (PROM) chips for storing static information e.g., start-up or BIOS instructions for processor 902.

The mass storage 910 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 912 communicatively couples processor(s) 902 with the other memory, storage, and communication blocks. The bus 912 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 902 to a software system.

Optionally, operator and administrative interfaces, e.g., a display, keyboard, and a cursor control device, may also be coupled to bus 904 to support direct operator interaction with the computer system. Other operator and administrative interfaces can be provided through network connections connected through communication port 904. An external storage device 910 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

In another embodiment, an application on the user's own device, may break down a complex query into its parts, retrieving results for these sub-queries, and then assembling the final answer. This application may accept the user's query and utilize various information sources needed to answer it. Additionally, the application may apply the user's private data to resolve a complex query, providing a more personalized and accurate response. In an embodiment, a meta-search engine or a broader service, such as a personal assistive service, may process a complex query to render a service to a user. For instance, a user may ask, “play me a hit song of some other popular musician from the same city as the one whose music I was listening to yesterday.” This integration with recommender systems and personal assistants enhances the capability of these services to handle complex queries. Currently, recommender systems use collaborative filtering and similar techniques to make recommendations based on similarity. However, they do not typically allow users to ask for recommendations with complex queries, especially when the song may have been played by another app that doesn't share data space with the primary search engine or smart assistants.

In an embodiment, the system may maintain a plurality of data spaces that categorize all user data into personal/protected data types. For each data type (e.g., email/calendar, e-commerce history, location, social media data, photo/media library, etc.), the user may predefine how such data can be used when accessed by another application (e.g., a search engine or smart assistants). When sharing personal data, metadata can be generated and associated based on predefined rules. This metadata can include information such as who can access it, how it should be handled, the purpose of its use, and the duration for which it can be used.

In an embodiment, the metadata fields can be updated either based on the predefined rules or based on the intended purpose. If the intended purpose is to resolve a complex query, the system may update the metadata field to ensure that the data retention time is minimal. Furthermore, the user's personal/protected data can be grouped into multiple categories (e.g., family, personal, professional, Organization-1, Organization-2, etc.). Access to user personal data can automatically be granted if the user making the query is authorized to access such data space. For example, personal data from multiple users can be stored in a data space. A data space for organization-1 may store all publicly accessible data (e.g., calendar) of user-1 and user-2 belonging to organization-1. If user-1, who has access to user-2's calendar, approves access to calendar data for a given query, permission from user-2 may not be required. This ensures efficient and secure access to personal data within defined boundaries and user authorizations.

The disclosed system and method (together termed as ‘disclosed mechanism’) for seamless execution of a complex query efficiently resolve complex queries across diverse operational environments, overcoming the drawbacks of present technologies. This mechanism offers several advantages in enhancing accuracy and completeness in query resolution. The mechanism thoroughly captures and processes all query components, and allows for systematic understanding and sequencing of sub-queries, ensuring that each sub-query is addressed in the correct order. This systematic approach optimizes query resolution and reduces potential errors or inconsistencies. The mechanisms' intelligent selection of data sources based on user settings, historical data access patterns, success records of similar queries, and metadata analysis enhances efficiency in accessing required private data while maintaining robust data security protocols. Additionally, the generated customized requests for private data access, along with detailed access attributes and messages for access approval, promotes transparency and accountability in data handling processes. This enhances trust and reliability, particularly in environments requiring stringent data governance. Furthermore, interactive approval processes with the access approver ensure controlled and validated data access based on specified criteria, thereby enhancing overall data security and compliance with organizational policies and regulatory standards.

For example, let's say the user wants to plan a family vacation and asks a smart assistant to handle the entire process. By utilizing the disclosed mechanism, the smart assistant can handle this complex query seamlessly. The user simply asks the smart assistant to plan a family vacation, and the assistant begins processing the request by capturing the entire complex query. Based on approval, from the user and family members, the smart assistant accesses the work calendar of user and family members to identify available vacation days. Further, the smart assistant retrieves and analyzes the calendar data to find suitable vacation periods. Furthermore, the smart assistant searches various travel websites to find flight options, leveraging historical travel data and user preferences to present the best choices. Moreover, the smart assistant then moves on to a hotel booking app to find and reserve a suitable hotel, again taking into account the user's past bookings and preferences. Additionally, the smart assistant generates a custom message to be sent to the user's family via their preferred messaging app. The message outlines the proposed vacation dates, flight options, and hotel reservations, including all necessary details for the family to review and confirm their availability.

To ensure privacy and compliance with data governance, the smart assistant takes explicit approval from the individuals whose private data it needs to access. This includes sending detailed access requests explaining the purpose and context of the data retrieval, as well as the retention period and potential impact of the data access. This interactive approval process ensures that all data is accessed with full transparency and user consent, enhancing trust and maintaining robust security protocols. By systematically processing the complex query and adhering to data privacy regulations, the disclosed mechanism provides a comprehensive and efficient solution for planning a family vacation, significantly improving user satisfaction and decision-making efficiency.

Overall, the mechanism for seamless execution of complex queries, integrates advanced parsing techniques, intelligent data source selection, and structured resolution processes, enhancing decision-making capabilities and operational efficiency across various query scenarios. These features collectively improve data handling, enhance security, and optimize performance in managing complex queries across diverse operational contexts.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art

What is claimed is:

1. A system for seamless execution of a complex query, the system comprising:
a query-receiving module to receive, at a first user device, a complex query comprising of two or more sub-queries, wherein to resolve at least a first sub-query of the two or more sub-queries access to a private data is required;
a query parser module to perform dependency parsing of the received complex query to determine the two or more sub-queries and an associated dependency order;
a data source selection module to select one or more data sources from a plurality of data sources, for accessing the private data, based on any or combination of user settings, historical access of data types from the plurality of data sources, success records of similar private data queries from the plurality of data sources, and analysis of metadata associated with each of the plurality of data sources;
a custom private data query module to:
generate and send at least one of: a private data access request, access attributes, and a custom message for access approver for the selected one or more data sources; and
receive the private data and inputs against each of the access attributes based on approval and interaction of the access approver; and
a query resolver module to resolve the first sub-query based on the received private data and subsequently resolve other sub-queries of the complex query based on the resolved first sub-query and the associated dependency order.

2. The system of claim 1, wherein the complex query is at least one of: a text query or a voice query.

3. The system of claim 1,
wherein the private data access request along with the access attributes, and the custom message is presented to the access approver.

4. The system of claim 1, wherein the access attributes comprise at least one of: information indicative of a retention period of the private data, permitted application that will use the private data, and specific context in which the private data is to be used.

5. The system of claim 1, wherein the received private data is used, maintained, or deleted based on the inputs received against each of the access attributes from the access approver.

6. The system of claim 1, wherein the custom message generated is a natural language message comprises at least one of: a reason for the access request, a potential impact of the data access, and a duration for which the data will be used.

7. The system of claim 1, wherein the first user device is one of a smart assistant device, a mobile phone, a tablet computer, or a general-purpose computer.

8. A method for seamless execution of a complex query, the system comprising:
receiving, at a first user device, a complex query comprising of two or more sub-queries, wherein to resolve at least a first sub-query of the two or more sub-queries access to a private data is required;
performing dependency parsing of the complex query to determine the two or more sub-queries and an associated dependency order;
selecting one or more data sources from a plurality of data sources, for accessing the private data, based on any or combination of user settings, historical access of data types from the plurality of data sources, success records of similar private data queries from the plurality of data sources, and analysis of metadata associated with each of the plurality of data sources;
generating and sending at least one of: a private data access request, access attributes, and a custom message for access approver for the selected one or more data sources;
receiving the private data and inputs against each of the access attributes based on approval and interaction of the access approver; and
resolving the first sub-query based on the received private data and subsequently resolve other sub-queries of the complex query based on the resolved first sub-query and the associated dependency order.

9. The method of claim 8, wherein the complex query is at least one of: a text query or a voice query.

10. The method of claim 8, wherein the private data access request along with the access attributes, and the custom message is presented to the access approver on a second user device.

11. The method of claim 8, wherein the access attributes comprise at least one of: information indicative of a retention period of the private data, permitted application that will use the private data, and specific context in which the private data is to be used.

12. The method of claim 8, wherein the private data is used, maintained, or deleted based on the inputs received against each of the access attributes from the access approver.

13. The method of claim 8, wherein the custom message generated is a natural language message, wherein the custom message comprises at least one of: a reason for the access request, a potential impact of the data access, and a duration for which the data will be used.

14. The method of claim 1, wherein the first user device is one of a smart assistant device, a mobile phone, a tablet computer, or a general-purpose computer.
